(19) United States
(12) Patent Application Publication
(10) Pub. No.: US 2004/0134117 A1
(43) Pub. Date: Jul. 15, 2004

(54) Fishing reel cover

(76) Inventor: Christopher T. Gagnon, Brooklyn Park, MN (US)

Correspondence Address: MOORE, HANSEN & SUMNER, 2900 WELLS FARGO CENTER, 90 SOUTH SEVENTH STREET, MINNEAPOLIS, MN, 55402, US

(21) Appl. No.: 10/340,825

(22) Filed: Jan. 10, 2003

(51) Int. Cl. A01K 97/08

(52) U.S. Cl. 43/26

(57) ABSTRACT

A protective cover for a fishing reel attached to a fishing rod. The protective cover comprises an enclosure having an interior chamber with a middle region and a predetermined circumference. The enclosure also includes first and second opposing ends with first and second panels and first and second apertures, respectively, through which the interior chamber may be accessed. The first aperture has a circumference that is smaller than, and offset relative to the internal circumference of the interior chamber, and the second aperture is variable in circumference from a first circumference that is larger than the internal circumference of said interior chamber to a second circumference that is smaller than the internal circumference of said interior chamber. The first, larger circumference of the second aperture facilitates insertion of a rod and reel into the interior chamber. Upon insertion, portions of the fishing rod protrude through the first and second apertures. The rod and reel are protectively secured within the interior chamber of the cover as the second aperture is varied from its first, larger circumference to its second, smaller circumference.

### FIELD OF THE INVENTION

This invention relates generally to a protective cover for a fishing apparatus. More particularly, this invention pertains to a protective cover that is configured to protectively enclose a reel and a portion of a fishing rod to which it is attached.

### BACKGROUND OF THE INVENTION

It is generally known to provide protective covers for fishing reels that are attached to fishing rods. These covers come in a variety of shapes and sizes, and the amount of protection available ranges from completely covering a rod and reel, to covering only the reel. See, for example, U.S. Pat. No. 4,546,877 issued Oct. 15, 1985 to Evans, and U.S. Pat. No. 4,876,819 issued Oct. 31, 1989 to Clifford. These types of covers have their drawbacks. With the cover of Evans, a major drawback is that it is large, cumbersome, non-collapsible and hard to store. Another drawback is as a rod is inserted into the cover the line guides are likely to catch on the end of the rigid tube and possibly break or become damaged. And, the part of the cover that covers the reel is not water-resistant. With the cover of Clifford, a drawback is that it does not have cushioning material. Thus, it is unable to protect the reel from damage during transport, storage, handling, −etc. Clifford's cover is one layer only. Another drawback is that the cover itself requires several distinct steps to install about a reel.

Other covers, such as U.S. Pat. No. 2,869,277 issued Jan. 20, 1969 to Breithaupt and U.S. Pat. No. 4,136,478 issued Jan. 30, 1979 to Wycosky are sock-like devices that are pulled over the bottom end of a fishing rod and reel. These, too, have their drawbacks. Both Breithaupt and Wycosky do not disclose the use of cushioning material in their covers. Rather, they disclose a single layer of flexible material. Thus, a reel positioned within such a cover would be subject to damage during transit, storage, handling, etc.

Yet other covers, such those shown in as U.S. Pat. No. 2,618,880 issued Nov. 25, 1952 to Sourek and U.S. Pat. No. 4,641,454 issued Feb. 10, 1987 to Ray et al. are configured to cover a reel and a portion of a rod However, they too, have their drawbacks. With the cover of Sourek, a user inserts a handle of a rod into an aperture and then wads the cover about a reel and a portion of the rod and secures it thereto. There is only one layer of material and it is not shock absorbent. Moreover, Sourek uses a one-piece design that results in different areas of the cover being stressed differently. This may result in different areas of the cover wearing out faster than other areas of the cover. The cover of Ray et al., on the other hand, is basically a cylindrical sleeve that is slipped over a rod and reel. After the cover is slipped onto a rod and reel, the ends are bunched up against respective portions of the rod and retained in position by hook and loop fasteners. While the cover of Ray et al., is substantially different that the cover of Sourek, it also has the drawback of uneven stress points. That is, the use of a single panel does not allow for a smooth transitioning between large and small areas. Additionally, since the form of the cover is in the shape of a cylinder, the likelihood that portions of the rod may become hung-up on and snag against the edge of the cover as it is being inserted into the cylinder is fairly high.

There is a need for a lightweight, protective, easily stored fishing reel cover that may be easily guided over and about a reel attached to a fishing rod. There is also a need for a lightweight, protective fishing reel cover that conforms to the shape of a reel positioned therein. There is also a need for a lightweight, protective fishing reel cover that is constructed and arranged so that stress points are minimized.

### SUMMARY OF THE INVENTION

The purpose of the fishing reel cover of the present invention is to provide a pliable, padded, form-fitting enclosure which can be easily slid onto a spinning reel or bait casting reel while the reel is attached to the fishing rod, and while the fishing line is positioned along the rod. The cover protects the reel from impact and environmental damage when the reel is not in use. The reel cover comprises a first main body panel of flexible material which has an outer layer of tear-resistant fabric such as rip-stop nylon and an inner layer of shock absorbent material such as foam rubber for protection of the fishing reel.

The cover also includes two opposing second and third panels. The second panel extends rearwardly relative to the first main body panel and includes an end that terminates in a first aperture. The first aperture is provided with an elastic member that is operatively connected thereabout and which enables the end of the second panel to snuggly engage the handle of a fishing rod when the handle extends therethrough. The elastic member also allows the first aperture to vary in size between first and second circumferences to allow the end of the second panel to accommodate fishing rod handles having different cross-sections configurations and diameters. Preferably, the central axis of the first aperture is in substantial collateral alignment with respect to the central axis of the middle region of the first, main body panel. This feature allows the cover to better accommodate the irregular cross-sectional shapes presented by different types of reels attached to different types of rods, because they present different cross-sectional shapes that are usually asymmetrical. The second (or rear) panel is formed from the same tear-resistant fabric such as rip-stop nylon as the first, main body panel.

The third panel extends forwardly relative to the first main body panel and includes an end that terminates in a second aperture. The third panel differs from the second panel in several respects. First, the second aperture does not have an elastic member that biases the aperture to a smaller circumference. Rather the second aperture is provided with a drawstring that may be manipulated to vary the size of the aperture between a first, large circumference and a second, smaller circumference. Moreover, the drawstring is provided with a slideable, lockable fastener that engages the drawstring and allows the second aperture to be temporarily secured in a fixed position. Another difference is that the construction and arrangement of the third panel allows the central axis of the second aperture to shift as it varies between its first and second circumferences. Thus, when the drawstring of the third panel is pulled tight and the second aperture closes around the fishing rod (with the reel inside the cover), the central axis of the second (and now constricted) aperture is in substantial collateral alignment relative to the central axis of the middle region of the first, main body panel. The central axis of the second aperture is also in substantial coaxial alignment with the central axis of the first aperture. On the other hand, when the lockable fastener attached to the drawstring is released and the second aperture is manipulated to its first, large circumference, the central axis of the second (and now distended) aperture shifts so that it is no longer in substantial coaxial alignment with the central axis of the first aperture. Another difference is that when the second aperture is in its first, large circumference, the third panel facilitates insertion of a rod and attached reel into the cover in a funneling action. As with the first, main body panel, the third panel has an outer layer of tear-resistant fabric such as rip-stop nylon and an inner layer of shock absorbent material such as foam rubber.

It is an object of the present invention to provide a fishing reel cover that may be used to cover a reel while it is attached to a fishing rod.

It is another object of the invention to provide a protective cover that may accommodate differently configured and differently sized reels.

It is yet another object of the present invention to provide a cover which is lightweight, easily transported and easily stored.

A feature of the present invention is that it is able to conform about differently configured reels.

Another feature of the present invention is the ability to effectively seal the cover and protect a reel placed therein form the elements by providing first and second opposing apertures at the first and second opposing ends of the cover that fit snuggly around the handle and shaft, respectively, of the rod.

Yet another feature of the invention is that when the cover is positioned about a reel and secured about the handle and shaft portions of a rod, the opposing first and second apertures at the first and second opposing ends of the cover are substantially aligned with the longitudinal axis of the rod.

Yet another feature is that the second aperture at the second end of the cover may be manipulated between a first circumference that is larger than the circumference of the interior of the cover, and a second circumference that is substantially smaller than the circumference of the interior of the cover.

Still another feature of the present invention is that the second end of the cover serves to guide the reel and rod into the interior of the cover.

An advantage of the invention is that a portion of the handle of a fishing rod is available for gripping.

Another advantage of the present invention is that the configuration of the first and second ends allows the central axes of the first and second apertures to be offset with respect to the central axis of the middle region of the cover and thus reduces stresses thereon when the cover is positioned over a reel and rod.

Another advantage of the present invention is that the cover may be folded or compressed into a compact shape when not in use.

These and other objects, features and advantages of the present invention will become apparent from the following detailed description thereof taken in conjunction with the accompanying drawing, wherein like reference numerals designate like elements throughout the several views.

### BRIEF DESCRIPTION OF THE DRAWINGS

FIG. 1 is a fragmented side plan view of an embodiment of a fishing reel cover in place about a reel and rod, with the apertures at the ends of the cover constricted against the handle and shaft of the rod;

FIG. 2 is a fragmented side plan view of an embodiment of a fishing reel cover in place about a reel and rod, with one of the apertures at the end of the cover open to a maximum circumference to permit insertion and withdrawal of a reel and rod;

FIG. 3 is a fragmented side plan view of an embodiment of a fishing reel cover prior to insertion of a reel and rod therein, or after withdrawal of a reel and rod therefrom;

FIG. 4 is a partial, sectional view of a cover that has been positioned about a reel and rod;

FIG. 5A is a partial, cross-sectional view of a cover that has been positioned about a first type of reel;

FIG. 5B is a partial, cross-sectional view of a cover that has been positioned about a second type of reel;

FIG. 6 is a partial, cross-sectional view of a cover in a collapsed configuration; and,

FIG. 7 is a plan view of a partially assembled cover illustrating a preferred arrangement of the first, second and third panels prior to joining the panel ends together and forming the cover.

### DESCRIPTION OF THE PREFERRED EMBODIMENT

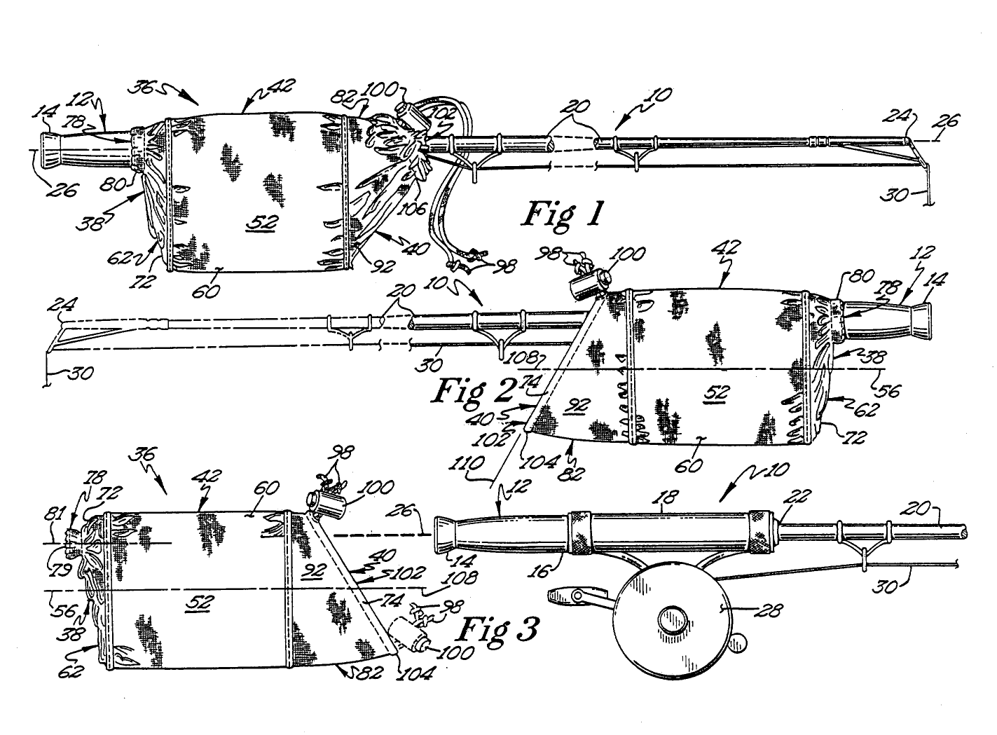

Referring to FIG. 1, a cover 36 is depicted in an installed position over a reel and a mounting section (See 18 in FIG. 3) of a fishing apparatus 10. As can be seen, a substantial portion of the handle 12 extends through one end 38 of the cover 40, while the working end of the rod 20, the rod tip 24 and a line 30 extend through the other end 40 of the cover 36. Note that the longitudinal axis 26 of the rod (and handle) is offset with respect to the cover 36. In this preferred embodiment, a handle 12 is available for gripping in the normal fashion, which facilitates handling of the fishing apparatus 10. It is understood, however, that not all handles need extend substantially through the end 38 in order for the cover 36 to be effective, and it is even envisioned that the cover 40 may be used with rods that do not have a handle per se.

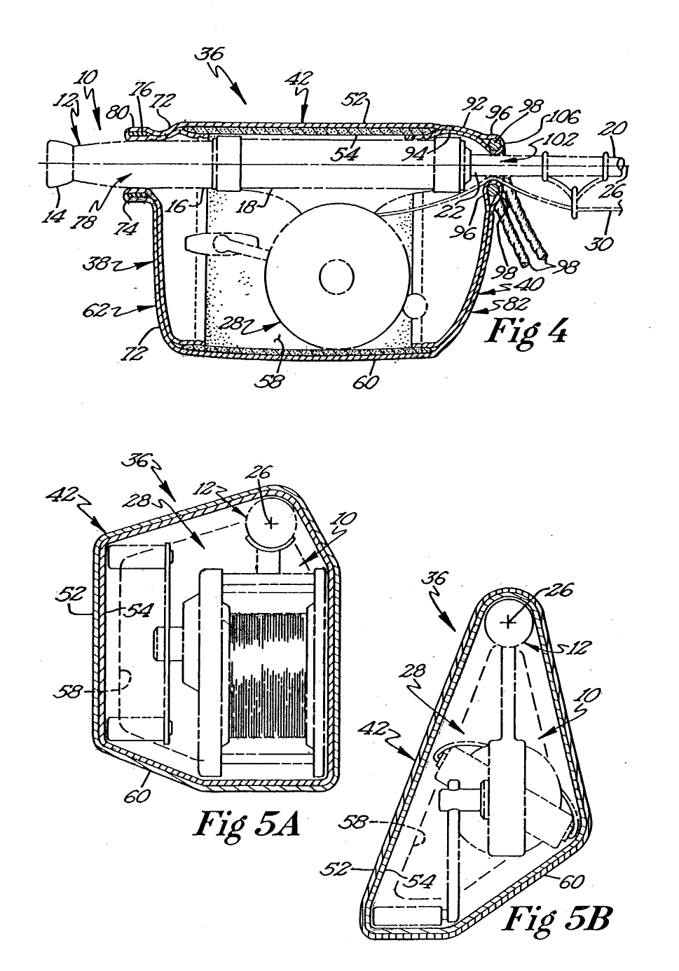

The cover 36 includes a first panel 42, a second panel 62 and a third panel 82. Starting from the left of the figure, the second panel 62 includes a first aperture 78 through which the heel end 14 of the handle 12 extends. As will become apparent, the first aperture 78 may vary from a first, small circumference 79 (See, FIG. 3) to a second, larger circumference 80. This amount of variation of the circumference of the aperture is dependent upon the characteristics of an elastic member that is operably connected to and positioned adjacent the aperture in a conventional casing (See, 76 of FIG. 4). Thus, the circumference may vary by an amount that corresponds to the elastic member between its relaxed and stretched states. The first aperture 78, as depicted in FIG. 1 is depicted as being the larger circumference 80. Note that the second panel 62 also provides a transition between the first aperture 78 and the first panel 42. Preferably, the transition is frustro-conical in shape, starting with the aperture 78 and gradually expanding to the circumference of the first panel 42. Moving towards the right, the first panel 42 of the cover 36 is configured to protectively encase a reel and a mounting portion of a rod (See, FIGS. 4, 5A and 5B).

Moving further to the right, the third panel 82 extends from the cover 36 in another frusto-conical transition and tapers towards a second aperture 102 that has a second, smaller circumference 106. When the cover is installed as depicted in FIG. 1, the central axes of the first and second apertures 78, 102 are in substantial coaxial alignment with the longitudinal axis 26 of the fishing apparatus 10. Note that first and second apertures 78, 102 are also offset with respect to the central axis 56 of the middle region 58 of the first panel 42. This offset allows the first and second apertures 78, 102 of the second and third panels 62, 82 to be gathered about a handle and a rod, respectively, and to also close the ends of the cover 36 in a sealing relation without having any stress points. The offset also prevents the first panel 42 from becoming twisted or deformed about the reel or be unduly drawn tautly against the reel, as would be the case if the first and second apertures were not offset with respect to the central axis 56 of the middle region 58 of the first panel 42. By positioning the first and second apertures 78, 102 in an offset relation, the first panel 42 is also less likely to tightly engage a reel and accidentally dislodge or interfere with fishing line retention mechanisms that may cause a fishing line to unravel or snarl. The third panel 82 may be maintained in a gathered position by a drawstring 98 and a conventional spring-loaded fastener 100. When the drawstring 98 is snugged up against the rod 22, it also clamps the line 30 and reduces the chances that the line become snagged on obstacles while the rod and reel are not in use. Although a fastener is preferred, it is understood that the drawstring may be manipulated and adjusted by forming a knot in the drawstring itself.

Referring now to FIG. 2, the spring-loaded fastener 100 has been released and the drawstring 98 has been loosened by an amount sufficient to allow the aperture 102 of the third panel 82 to be expanded to a first circumference 104. Comparing FIGS. 1 and 2, note that in moving between the different circumferences 106, 104 several things occur. One, the central axis 108 of the aperture 102 moves by shifting closer to the central axis 56 of the first panel 42. That is, the central axis 108 of the aperture 102 shifts from a location that is in substantial coaxial alignment with the central axis 81 (See, FIG. 3) of the first aperture 78 and offset relative to the central axis 56 of the middle region 58 of the cover 36 (See, FIG. 2, 58 depicted in dashed lines) to a location that is in substantial coaxial alignment with the central axis 56 of the middle region 58 of the cover 36 and offset relative to the central axis 81 of the first aperture 78. Two, the plane 110 of the aperture-102 changes from being substantially parallel to the plane of the first aperture 78 to being skewed with respect to the plane of the first aperture 78. And three, the first circumference 104 becomes greater than the circumference of the first panel 42 of the cover 36.

With reference to FIG. 3, a fishing apparatus 10 is depicted in a juxtaposed relation to the cover 36 prior to insertion or subsequent to removal therefrom. In this depiction, the elastic member 76 biases the first aperture 78 of the second panel 62 towards a first, smaller circumference 79. As shown, the central axis 81 of the first aperture 78 of the second panel 62 is in substantial coaxial alignment with the longitudinal axis 26 of the fishing apparatus 10 and offset with respect to the central axis 56 and the middle region 58 of the cover 36. The central axis 108 of the second aperture 102, on the other hand, is in general alignment with the central axis 56 and the middle region 58 of the cover 36. It should be apparent, by now, that the provision of the larger circumference 104 of the second aperture 102 enables the third panel 82 to act as a guide for a rod and reel and reduce snagging of parts as the cover is slid in place.

With reference to FIG. 4, the juxtaposition of a rod and reel within the cover 40 may be seen. Starting from the left side, the first aperture 87 of the second panel 62 is maintained in its second, larger circumference 80 by the mounting section 18 of the fishing apparatus 10 acting against the biasing force of the elastic member 76. The second panel then enlarges as it makes a transition to the first panel 42 that is configured to substantially envelope a reel 28 that is attached to a mounting section 18 of a fishing apparatus 10. As can be seen, the first panel 42 comprises a first, outer layer 52 and a second, inner layer 54. Preferably, the first layer 52 is a flexible and waterproof or water-resistant material such as nylon and the second layer is a flexible, shock absorbent material such as foam rubber. Continuing on, the third panel 62 contracts as it makes a transition from the first panel 42 to the second circumference 106 of the second aperture 102. At the second aperture 102, the second circumference 106 is maintained in position by the drawstring 98 that draws the aperture 102 about the base 22 of the rod 20 and the line 30. As with the first panel 42, the third panel 62 has a first and second layers 92, 94 of flexible, waterproof or water-resistant, and shock absorbent materials, respectively. Thus installed, the cover 36 not only protects the reel from physical damage during transit, storage and handling but also from harmful environmental factors such as dust, dirt, ice, mud, ultra-violet radiation and moisture.

FIGS. 5A and 5B illustrate the ability of the cover 36 to conform about different types of reels that are configured differently. For example, in FIG. 5A, the reel is depicted as traditional casting reel. As can be seen, the first panel 42 conforms to the shape of the reel 28 and the first panel assumes a rather squarish cross-section. Note that the middle region 58 (shown in dashed lines) will also reflect this cross-section. On the other hand, the reel 28 in FIG. 5B is depicted as a spinning reel, and as the first panel 42 conforms to the shape of that particular reel, the first panel 42 assumes a somewhat triangular cross-section. As with FIG. 5A, the middle region 58 (also shown in dashed lines) reflects this triangular cross-section. Note, in FIGS. 5A and 5B that the handle 12 of the fishing apparatus is adjacent the inner layer 54 of the first panel 42, and the longitudinal axis 26 is offset with respect to the middle region 58. It should be understood that FIGS. 5A and 5B are merely examples of the types of reels that may be used with the cover 36 and that the cross-sections that the first panel 42 may assume may be considerably different. It should also be understood that a singular reel may also produce different cross-sections by moving the position of the crank arm.

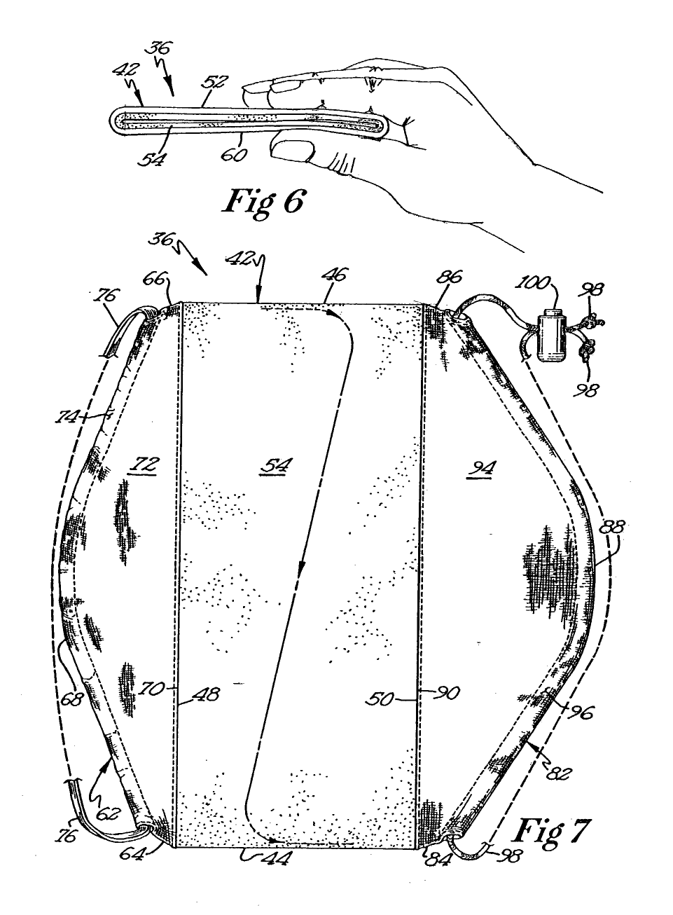

Turning to FIG. 6, the first panel 42 of the cover 36 is shown in a collapsed state. The collapsibility of the cover 36 enables the cover to be easily carried and transported on a person or in a tackle box, for example, when it is not used in conjunction with a fishing apparatus.

Referring now to FIG. 7, the preferred construction of the cover 36 is depicted in a partially disassembled, and opened state and the three panels 42, 62, 82 may be easily discerned. Starting at the center, the first panel 42 is generally rectangular in shape and includes opposing ends 44, 46 and opposing sides 48, 50. Note that the inner layer 54 of shock absorbent material is substantially the same size as the outer layer of water-resistant/waterproof material 52.

The second panel 62 is generally triangular in shape and also includes opposing ends 64, 66 and opposing sides 68, 70. The opposing side 70 of the second panel 62 may be attached to the opposing side 48 of the first panel 42 by stitching, for example (shown in dashed lines). The opposing end 68 of the second panel 62 defines the circumference of the first aperture 78. In order to provide for movement between a first, small circumference 79 and a second, larger circumference 80, the opposing end 68 is provided with a casing 74 that receives the elastic member 76.

The third panel 82, like the second panel, is also generally triangular in shape and also includes opposing ends 84, 86 and opposing sides 88, 90. The opposing side 90 of the third panel 82 may also be attached to the opposing side 50 of the first panel 42 by stitching (shown in dashed lines). The opposing end 88 of the third panel 82 defines the circumference of the second aperture 102. In order to provide for movement between a first, larger circumference 104 and a second smaller circumference 106, the opposing end 88 is provided with a casing 96 which receives the drawstring 98.

To finish assembly of the cover 36, the opposing ends of the first, second and third panels 44, 46, 64, 66, and 84, 86, respectively are brought into confronting relation and attached to each other in a conventional manner such as stitching. The elastic member 76 may then be snugged up to a predetermined length and secured so that the first aperture is biased towards a first circumference 79. The drawstring 98 may then be provided with an appropriate fastener 100.

A brief description of the operation will now be described. To place the cover around a reel that is attached to a rod, the second aperture of the cover is first opened up to its first, largest circumference. Then a fishing rod and reel are positioned so that the handle end is adjacent the second aperture. The cover is then pulled or slid over the handle and reel towards the tip or forward end of the rod. As the reel is received within the interior of the cover, the heel end of the handle should be aligned with the first aperture so that it will be able to extend through the first opening. As the heel end encounters and extends therethrough, the elastic member will allow the first aperture to expand and will effectively seal the first aperture about the handle. Preferably, the cover will be slid onto the rod and reel until the body of the cover is centered with respect the reel. At this point, the second aperture may now be configured from its first, large circumference towards its second, smaller circumference. This is accomplished by reducing the size of the loop formed by the drawstring and its attendant fastener. As the size of the loop is reduced, the second aperture constricts about the portion of the rod that extends therethrough until the second aperture effectively forms a seal with the rod. The drawstring may then be secured by utilizing the fastener or by simply tying the ends together in a knot. Removal of a rod and reel from the cover is essentially the reverse of the aforementioned procedure.

Thus described, this invention provides a cover that allows a reel to be protected from the elements without having to remove the reel from a fishing rod.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A fishing reel cover comprising:
a sleeve having a central axis and first and second ends, a first variable size aperture being positioned in said first end and a second variable size aperture being positioned in said second end;
said first variable size aperture having a central axis, with said central axis of said first variable size aperture laterally offset with respect to said central axis of said sleeve, and,
said second variable size aperture having a central axis, with said central axis of said second variable size aperture shiftable between a position that is in substantial coaxial alignment with respect to the central axis of said sleeve to a position that is in substantial coaxial alignment with the central axis of said first variable size aperture.

2. The cover of claim 1, wherein said first end of said sleeve comprises a panel having an edge which defines said first variable size aperture.

3. The cover of claim 2, wherein said first panel further comprises an elastic member adjacent said first variable size aperture and operable to permit the circumference said first aperture to be elastically expanded by an object positioned therein.

4. The cover of claim 1, wherein said second end of said sleeve comprises a second panel having an edge which defines said second variable size aperture.

5. The cover of claim 4, wherein the second panel further comprises a flexible member positioned substantially about the edge of said second aperture and operable to sealingly constrict said second aperture about an object positioned therein.

6. The cover of claim 1, wherein said cover comprises a flexible walled material.

7. The cover of claim 1, wherein said sleeve comprises a first exterior layer of material and a second interior layer of material.

8. The sleeve of claim 7, wherein one of said layers of material is water-resistant, and the other layer of material is shock absorbent.

9. The cover of claim 4, wherein said second panel comprises a first exterior layer of material and a second, interior layer of material.

10. The second panel of claim 9, wherein one of said layers of material is water-resistant and the other layer of material is shock absorbent.

11. A fishing reel cover comprising:
a flexible walled sleeve having first and second opposing ends,
with the first opposing end including a first flexible panel with a first aperture having a central axis that is laterally offset with respect to the central axis of said sleeve;
and with the second opposing end of said sleeve including a second flexible panel with a second, variable size aperture having a central axis that shifts with respect to the central axis of said sleeve as said second aperture is varied.

12. The cover of claim 11, wherein said first aperture is variable size and includes an elastic member positioned substantially therearound and operable to permit said first aperture to be elastically expanded by an object positioned therein.

13. The cover of claim 11, wherein said second aperture includes a flexible member positioned substantially therearound and operable to permit said second aperture to sealingly constrict about an object positioned therein.

14. The cover of claim 11, wherein said flexible walled sleeve and said second flexible panel comprise an exterior layer of water-resistant material and an interior layer of resilient, shock absorbing material.

15. A fishing reel cover usable with a reel attached to a fishing rod, the fishing reel cover comprising:
an enclosure comprising an interior chamber with a middle region and a predetermined internal circumference, said enclosure further comprising first and second opposing ends, with said first and second opposing ends including first and second apertures, respectively, said interior chamber being accessible through said first and second apertures;
said first aperture having a circumference, said first aperture circumference being smaller than the internal circumference of said interior chamber;
said second aperture having a circumference which is variable from a size that is at least as large as the internal circumference of said interior chamber of said enclosure to a size which substantially smaller than the internal circumference of said interior chamber;
wherein said larger circumference of said second aperture facilitates insertion of a rod and attached reel into said interior chamber; wherein a portion of a rod extends through said first aperture when a rod and attached reel are received within said interior chamber; and wherein a rod and attached reel are protectively secured within said interior chamber of said cover as said second aperture is reduced from its larger size to a smaller size where it is closely engagable with a rod.

16. The cover of claim 15, wherein said first aperture includes a central axis that is tangentially oriented with respect to said middle region of said interior chamber.

17. The cover of claim 15, wherein said second aperture includes a central axis that shifts laterally with respect to said interior chamber of said cover as said second aperture is varied.

18. The cover of claim 15, wherein said first and second apertures each include a central axis, and the central axes of the first and second apertures are brought into substantial coaxial alignment when the circumference of said second aperture is varied from its large to its smaller size.

19. The cover of claim 15, wherein said first aperture is variable size and includes an elastic member positioned about the edge thereof and which is operable to bias said first aperture towards a smaller circumference.

20. The cover of claim 15, wherein said aperture further includes a drawstring extending substantially thereabout and operable to vary the circumference of said second aperture.
